(19) United States
(12) Patent Application Publication
(10) Pub. No.: US 2012/0179363 A1
(43) Pub. Date: Jul. 12, 2012

(54) ROUTE CALCULATION AND GUIDANCE WITH CONSIDERATION OF SAFETY

(75) Inventor: Jeffrey Edward Pierfelice, Canton, MI (US)

(73) Assignee: Toyota Motor Engineering & Manufacturing North America, Inc., Erlanger, KY (US)

(21) Appl. No.: 12/985,661

(22) Filed: Jan. 6, 2011

(51) Int. Cl. G01C 21/36

(52) U.S. Cl. 701/423; 701/435

(57) ABSTRACT

The present invention discloses a navigation system and process for providing a second route to a user of the system when a first route determined by the system passes through an area that has a safety level that is less than a predefined and desired safety level.

### FIELD OF THE INVENTION

The present invention relates to a navigation process for a motor vehicle, and in particular, to a navigation process for providing an alternate route to a user when a suggested route passes through an area having a safety level less than a predefined safety level.

### BACKGROUND OF THE INVENTION

Navigation systems such as UPS systems and the like for use within motor vehicles are known. Such systems allow for a user to input a desired final destination or location, and the system, taking into account the current location of the motor vehicle, calculates a navigation route to the final destination. Such systems can be particularly useful for individuals unfamiliar with roads within a given area, state, country, etc.; however, one's unfamiliarity with a particular area, road, highway, etc. can result in an individual driving in an area that is not safe relative to the individual's comfort level with respect to crime, traffic congestion, and the like. For example, a particular area can have a relatively high crime rate, a relatively dangerous intersection, a congested traffic pattern, etc., that the individual would desirably avoid if the knowledge of, and/or the opportunity to drive around, the area. Therefore, a navigation system and navigation process that can provide an alternate route to a user when a suggested route passes through an area that has a safety level less than a predefined and desired safety level would be desirable.

### SUMMARY OF THE INVENTION

The present invention discloses a navigation system and process for providing a second route to a user of the system when a first route determined by the system and/or passes through an area that has a safety level that is less than a predefined and desirable safety level. The navigation system can include a GPS system and a database with safety data as a function of geographical area. The system can also have a route module that can determine a first navigation route and a second navigation route. The first navigation route can be a function of a current location of the motor vehicle and a desired future location or destination point. The second navigation route can be a function of the first navigation route, i.e. the current location and the destination point, and the safety data. A safety level module can also be included, the safety level module able to determine a safety level for an area that the first navigation route passes through, the safety level being a function of the safety data for the area.

In the event that the user inputs a navigation request such as a final destination point or address, and the navigation system calculates a first navigation route that passes through an undesirable area, the navigation system can alert or present an alarm to the user and then query the user as to whether or not the user desires to view one or more safety alerts associated with the undesirable area, take an alternate route bypassing the undesirable area, and the like. If the user desires to view the safety alerts, the system can allow the user to select or ignore one or more of the safety alerts and then query whether or not to calculate a second navigation route as a function of the selected and/or ignored safety alerts. The safety data and the safety alerts can be related to or be a function of crime data and/or highway safety data.

The navigation system can also provide an alarm to a user if the system, and thus the user, enter into an undesirable area. In some instances, the alarm can be provided to the user whether or not the navigation system is currently being used to provide a navigation route to the user. In the event that the user has entered an undesirable area, the navigation system can query the individual as to whether or not the user wants to exit the area or continue along a route currently being traveled. If the user selects to exit the area, the system can further query the user as to which type of exit route is desired. For example, the system can provide a shortest route, a safest route, and/or a fastest route for the user select and thereby exit the undesirable area.

A navigation process includes providing the navigation system as described above into which a user inputs a desired final destination. The navigation system determines a first navigation route and determines a safety level for an area that the first navigation route passes through. The navigation system also determines a second navigation route if the safety level for the area that the first navigation route passes through is less than the predefined safety level. It is appreciated that the second navigation route avoids the area having the safety level less than the predefined safety level.

### BRIEF DESCRIPTION OF THE DRAWINGS

FIG. 1 is a schematic illustration of a display for a navigation system according to an embodiment of the present invention, the display showing a street map with a current location of the navigation system noted thereon;

FIG. 2 is a schematic illustration of the navigation system shown in FIG. 1;

FIG. 3A is a schematic flowchart illustrating a process according to an embodiment of the present invention;

FIG. 3B is a schematic illustration of the navigation system display shown in FIG. 1 on which a query is provided to a user as to whether or not to review one or more alerts associated with an area that a navigation route passes through;

FIG. 3C is a schematic illustration of the navigation system display shown in FIG. 3B on which one or more alerts can be reviewed and a query is provided to a user as to whether or not to ignore one or more of the alerts and whether or not to recalculate a navigation route;

FIG. 4A is a schematic flowchart illustrating a process according to another embodiment of the present invention;

FIG. 4B is a schematic illustration of the navigation system display shown in FIG. 1 on which at least one difference between a first navigation route and a second navigation route is provided to a user;

FIG. 4C is a schematic illustration of the navigation system display shown in FIG. 4B on which a query is provided to a user as to whether or not to review one or more alerts associated with an area that a navigation route passes through;

FIG. 4D is a schematic illustration of the navigation system display shown in FIG. 4C on which one or more alerts can be reviewed and a query is provided to a user as to whether or not to ignore one or more of the alerts and whether or not to recalculate a navigation route;

FIG. 5A is a schematic flowchart of a process according to another embodiment of the present invention;

FIG. 5B is a schematic illustration of the navigation system display shown in FIG. 1 on which an alarm related to an alert area and a query as to whether or not to exit the alert area are provided to a user; and

FIG. 5C is schematic illustration of the navigation system display shown in FIG. 5B on which a query is provided to a user as to which type of route is desired to exit the alert area.

### DETAILED DESCRIPTION OF THE INVENTION

The present invention discloses a navigation system and a navigation process for providing an alternate route to a user when a first calculated route passes through an undesirable area. As such, the present invention has utility as a navigation system and/or as a component for a motor vehicle.

The navigation system can include a GPS system known to those skilled in the art for travel, e.g. travel using a motor vehicle. In addition, a database with safety data, the safety data being a function of, keyed to and/or associated with geographical area can be included. The safety data can include crime data such as statistical crime data, and highway safety data such as statistical accident data, traffic volume data, traffic congestion data, and the like. The crime data can be sorted or keyed with respect to different times of the day, dates or ranges of dates, weather, temperature, phase of the moon, precipitation, local terrain, land use including zoning, and the like. In addition, the crime data can be related to the type of crime such as auto theft, drug arrests, traffic violations, assaults, etc.

The highway safety data can be related to total number of accidents and/or number of accidents per period of time for a given stretch of road or highway, total number of accidents and/or number of accidents per period of time at a particular intersection, traffic volume and/or traffic congestion on a road or highway for a given time of day or range of day times, and the like. It is appreciated that other safety related factors, safety related statistics, long-term historical safety data, etc., known and/or used by travel agencies, law enforcement agencies, city governments, county governments, state governments and/or federal governments can be stored in the database and used by the navigation system.

The navigation system can include a route module that can determine a first navigation route and a second navigation route. The first navigation route can be a function of a current location of the navigation system and a desired future location or destination point. The second navigation route can be a function of the current location, the desired future location, and the safety data.

A safety level module can also be included within the navigation system, the safety level module able to determine a safety level for at least one area that the first navigation route passes through. The safety level module determines the safety level as a function of the safety data associated with the area. In the event that the first navigation route passes through an undesirable area, that is an area that has a safety level that is less than a predefined safety level, the route module can calculate a second navigation route that bypasses the undesirable area.

In some instances, the predefined safety level can be a user input safety level and may or may not include at least two user input safety levels in which each safety level is related to or is a function of a particular user. For example and for illustrative purposes only, a user such as a parent, adult, etc., feeling fairly confident about his or her ability to avoid trouble, crime, etc., can have a first predefined safety level while another user, for example a different member of the family such as a grandparent, a teenager, etc., can have a second safety predefined level. It is appreciated that the navigation system can also have a third, fourth, fifth, predefined safety level for different users of the navigation system and/or for the same user when traveling under different conditions such as different times of the day or night, different weather conditions, etc.

In use, a user can input a desired destination point and the navigation system can determine a first navigation route that the user can follow/travel from the current location to the destination point. In the event that the first navigation route passes through an area that has a safety level less than a predefined safety level for that particular user and/or system, the system can provide a query to the user as to whether or not to review one or more alerts related to at least one area that the first navigation route passes through. If the user selects to review the one or more alerts, the system can provide to the user a listing of the one or more alerts, and optionally include a safety ranking or safety level for each type of alert. Stated differently, the one or more alerts can be rated as a function of the safety data, weather conditions, time of day or night, etc. The system can also provide a query to the user as to whether or not to select or ignore one or more of the alerts and whether or not to calculate a second navigation route as a function of the alerts selected by the user. If desired, the navigation system can calculate the second navigation route which can avoid and/or bypass at least part of the undesirable area depending on the user's decision with respect to selecting or ignoring the safety alerts.

The navigation system can also calculate a second navigation route and provide one or more differences between the first navigation route and the second navigation route. For example and for illustrative purposes only, differences such as a difference in distance between the two navigation routes, a difference in estimated travel time between the two navigation routes, and a difference in distance and travel time between the two navigation routes can be provided to the user.

The system can further determine a safety level of a current location of the navigation system and provide an alarm if the navigation system is located and/or has entered an area that has a safety level that is less than a predefined safety level. A query can be provided to the user as to whether or not to exit the undesirable area, and if the user selects to exit the area, the system can query the user as to which type of route is desired to exit the area. For example, the system can calculate and/or provide a shortest route, a safest route, a fastest route, etc., to exit the undesired area.

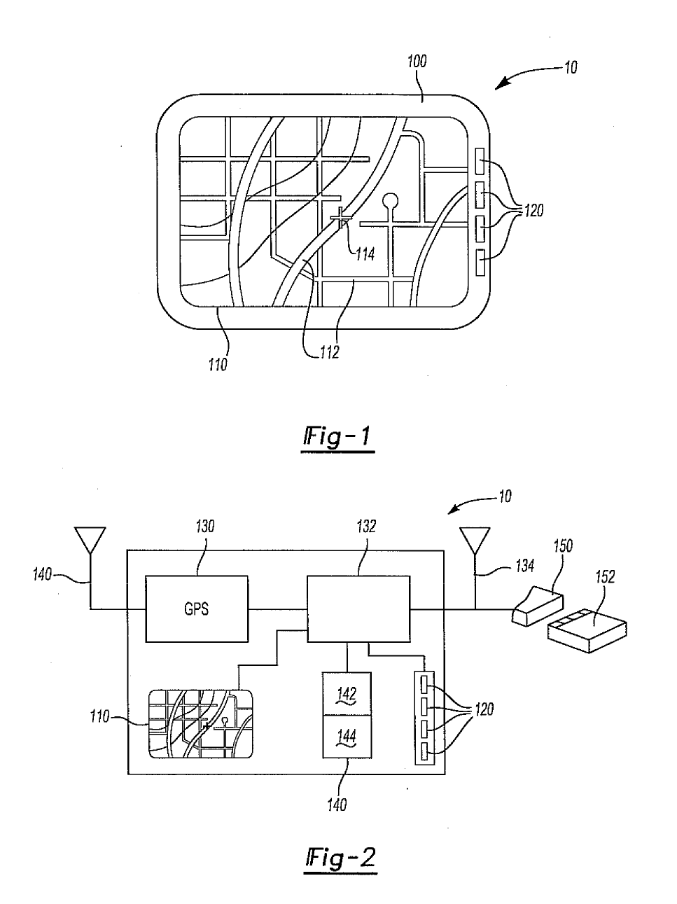

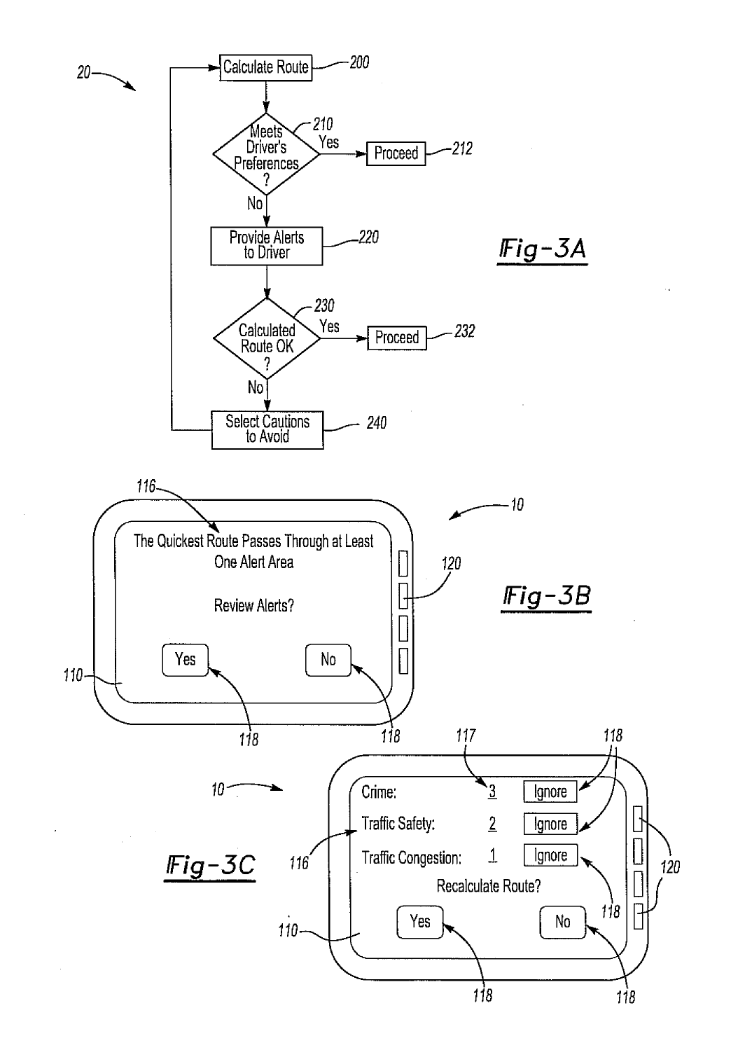

Turning now to FIGS. 1 and 2, a schematic illustration of a navigation system is shown generally at reference numeral 10. The system 10 can include a frame 100 that borders a display 110 and can optionally include one or more operation buttons 120. The operation buttons 120 can afford for an individual to select and/or scroll through a menu for the navigation system 10 as is known to those skilled in the art. The display 110 can display a street map having a plurality of streets, highways, and the like 112 along with a current location 114 of the navigation system shown on the street map. In this manner, a user can determine their current location relative to a street map and which road, highway, etc. they are traveling on. In addition, it is appreciated that the navigation system 10 can be contained within or be part of a motor vehicle, however this is not required.

FIG. 2 illustrates a more detailed schematic illustration of the navigation system 10 with the system 10 having the display 110, the operation buttons 120, and a GPS receiver 130 that can communicate with a microprocessor 132. In addition, the system 10 can include a GPS antenna 140 and the microprocessor 132 can be in communication with a database 140 that can include map data 142 and safety data 144. The safety data 144 can include data related to crime statistics, highway safety statistics, traffic volume or congestion statistics, and the like, the data naturally being associated with or keyed to geographical areas contained within the map data 142.

The microprocessor 132 can be in communication with an antenna 134 and/or a socket 150 that can engage a standard memory card 152, compact disc, memory stick, and the like. It is appreciated that the antenna 134 and/or the socket 150 can be used to back up and/or upgrade the data stored in database 140. In addition, the antenna 134 can be used to receive current information and/or data related to weather conditions, traffic conditions, crime, etc., for one or more areas that the navigation system 10 calculates that a route will pass through.

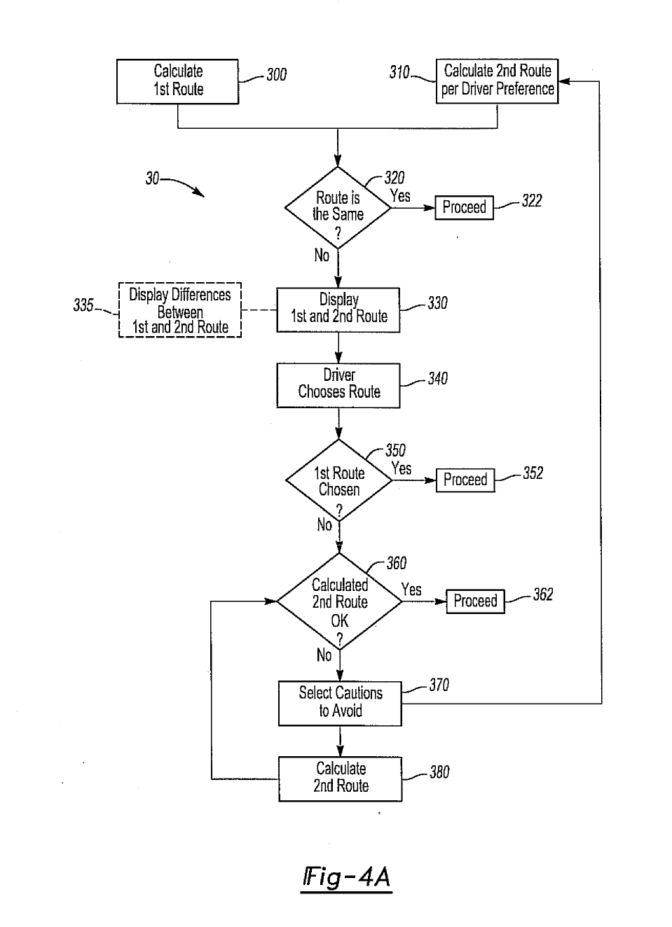

FIG. 3A provides a schematic flowchart for a process 20 according to an embodiment of the present invention in which a motor vehicle has an inventive navigation system as disclosed herein. The process 20 includes calculating a route at step 200 and then determining whether or not the route meets a driver's or user's preference at step 210. If the route meets a driver's preference or preferences, then the navigation system 10 can proceed to instruct the drive regarding the route at step 212. In the event that the route does not meet the driver or user's preferences, one or more alerts can be provided to the driver at step 220. At step 230, the driver can be provided with a query as to whether or not the calculated route is okay to proceed with. If the driver elects to proceed with the calculated route, the navigation system can proceed to instruct the driver regarding the route at step 232. In the alternative, the driver is provided the opportunity as to which cautions or alerts to avoid at step 240 and the route can be calculated again at step 200 as a function of the cautions or alerts that were selected to be avoided at step 240.

An illustrative example of at least a portion of the process 20 displayed using the navigation system 10 is shown in FIGS. 3B and 3C. In particular, FIG. 3B schematically illustrates the system 10 using the display 110 to provide an alert using text 116 to the driver that a calculated route, for example a route calculated to take the least amount of time to travel from a current location to a desired location, passes through at least one area that does not meet the driver's preference(s). In addition, a query can be provided to the user as to whether or not to review the alerts related to the at least one alert area. Selection of whether or not to review the alerts can be performed using the one or more operation buttons 120, or in the alternative, touch screen buttons or boxes 118 on the display 110 can be touched or depressed by the user.

In the event that the user does select to review the alerts, FIG. 3C provides a schematic illustration of different types of alerts and an optional rating or safety level 117 for each alert. As shown in the figure, a crime alert, a traffic safety alert, and a traffic congestion alert can be provided via text 116 with the optional rating 117 and an ability to ignore one or more of the alerts provided.

The user can have a predefined rating or safety level that above which he or she desires to receive an alert. For example, if the alert 117 for crime is equal to or greater than 3 for an area that the route passes through, the user can request that an alert be shown as illustrated in FIG. 3C. For another example, if the alert for traffic safety, which may or may not be related to the number of accidents associated with a particular intersection and/or stretch of road that the route passes through, is equal to or greater than 2, the user can request that an alert be shown. It is appreciated that the safety levels can be set using the operation buttons 120, touch screen buttons, by a factory dealer, wirelessly through a road assistance program, and the like.

Returning to FIG. 3C, the display 110 can also provide a query to the user as to whether or not to recalculate the route as a function of the alerts shown on the screen and whether or not any of the alerts are to be ignored. Although the term “alerts” is used in the figures, it is appreciated that terms such as alarms, cautions, and the like can be used interchangeably. In addition, the term “rating” can be interchanged with terms such as safety level, alarm level, alert level and the like.

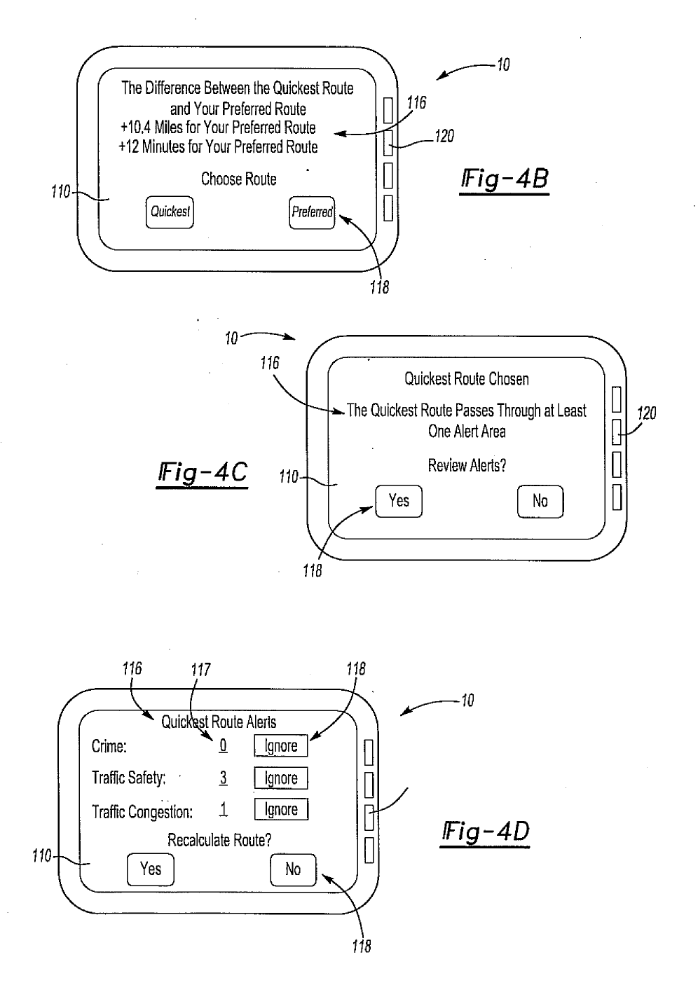

Turning now to FIG. 4A, a navigation process 30 according to another embodiment of the present invention is shown. The process 30 can include calculating a first route at step 300 and calculating a second route per at least one user or driver preference at step 310. It is appreciated that the driver preference can be a predefined safety level and the second route is calculated as a function of the first route and the predefined safety level whereas the first route is calculated per shortest length and/or quickest travel time considerations.

At step 320, the first route and the second route can be compared to each other to determine if they are the same route. In the event that the first route and second route are the same, the system 10 can proceed to instruct the driver regarding the route at step 322. In the alternative, the first route and the second route can be displayed at step 330 and/or at least one difference between the first and second routes can be displayed at step 335. At step 340, the driver can choose which route to take. If the first route is chosen, step 350 affords for the system 10 to proceed to instruct the driver regarding the first route at step 352. If the first route is not chosen, step 350 affords for a query as to whether or not the calculated second route is acceptable at step 360. If the second route is acceptable, the system can proceed to instruct the driver regarding the second route at step 362. In the alternative, the process 30 can provide cautions or alerts to the user and the user can select which cautions or alerts to avoid or ignore at step 370.

In some instances, after the cautions or alerts have been selected or ignored at step 370, the second route can be recalculated per the updated driver preference at step 310 and the process can cycle or begin again by comparing the first route and second route at step 320. In other instances, the second route can be calculated at step 380 with the process returning to step 360 and providing a query to the driver as to whether or not the second route is acceptable.

Turning now to FIGS. 4B-4D, an illustrative example of at least a portion of the process 30 is shown with respect to system 10. In FIG. 4B, the system 10 provides information to the user of at least one difference between a quickest route and a preferred route, for example the first calculated route and the second calculated route in FIG. 4A, with the difference in mileage and estimated time shown. In addition, a query is provided to the user as to which route to choose, for example the quickest route or the preferred route, by activating one of the touch screen buttons 118 or operations buttons 120.

FIG. 4C illustrates that the driver has chosen the quickest route and that the quickest route passes through at least one area that has an alert. Similar to FIG. 3B, the system 10 provides a query to the driver as to whether or not to review the alerts. In addition, FIG. 4D, similar to FIG. 3C, provides a listing of one or more alerts, the opportunity for the driver to ignore one or more of the alerts, and whether or not to recalculate the route.

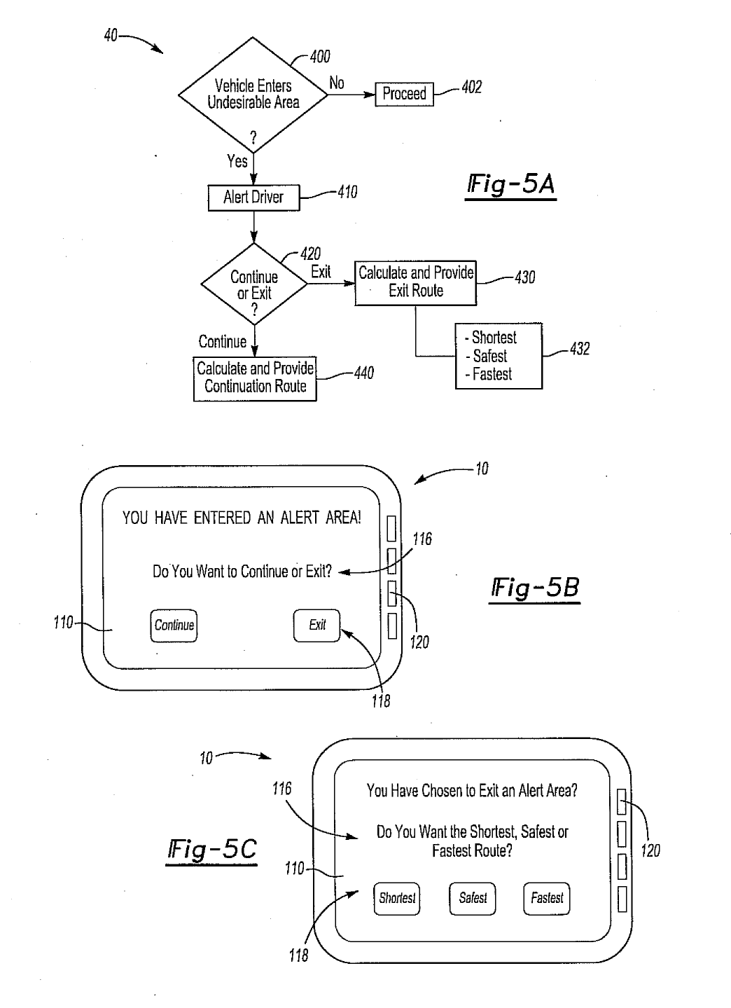

FIG. 5A illustrates a process 40 according to another embodiment of the present invention in which the navigation system 10 enters an undesirable area. At step 400, the navigation system determines whether or not the system 10 has entered an undesirable area. If not, then the system, e.g. in use within a motor vehicle, is allowed to proceed at step 402 without any alert provided to the driver. In the alternative, and in the event that the vehicle has entered an undesirable area, an alert or an alarm can be provided to the driver at step 410. In addition, the driver can be provided with a query as to whether to continue along a route presently being traveled on or to exit the area at step 420. If the driver selects to continue as presently proceeding, the process continues to step 440 in which a continuation route can be provided. In the alternative, if the individual wishes to exit the area, step 430 provides for the calculation of an exit route. It is appreciated that the exit route can be a shortest exit route, a safest exit route, a fastest exit route, and the like.

In some instances, the inventive navigation system 10 can enter an undesirable area. It is appreciated that the system 10 can enter the undesirable area when it is in use, or in the alternative, with it is not in use. As such, the navigation system 10 is designed to afford for the user to be alerted upon entering an undesirable area whether or not the system 10 is in use.

FIG. 5B provides an example illustration of the navigation system 10 providing an alert to the driver that he or she has entered an alert area and a query as to whether or not the driver wants to continue or exit. Upon selecting to exit the area FIG. 5C illustrates that the system 10 provides the driver with an option as to which type of exit route is desired. For example, the touch screen buttons 118 provide for the driver to select a shortest route, a safest route, or a fastest route.

In view of the teaching presented herein, it is to be understood that numerous modifications and variations of the present invention will be readily apparent to those of skill in the art. The invention is not restricted to the illustrative examples or embodiments described above. The examples or embodiments are not intended as limitations on the scope of the invention. Methods, processes, systems, and the like described herein are exemplary and not intended as limitations on the scope of the invention. Changes and other uses will occur to those skilled in the art. As such, the scope of the invention is defined by the scope of the claims.

I claim:

1. A navigation process for providing an alternate route to a user when a suggested route passes through an area having a safety level less than a predefined safety level, the process comprising:
providing a navigation system for a motor vehicle, the navigation system having:
a database with safety data as a function of geographical area;
a route module for determining a first navigation route and a second navigation route, the first navigation route being a function of a current location and a desired future location, and the second navigation route being a function of the first navigation route and the safety data;
a safety level module for determining a safety level for an area the first navigation route passes through as a function of the safety data for the area;
providing a navigation request to the navigation system;
determining a first navigation route;
determining a safety level for an area that the first navigation route passes through;
determining a second navigation route if the safety level is less than a predefined safety level, the second navigation route avoiding the area with the safety level less than the predefined safety level;
providing the user with the second navigation route if the safety level is less than the predefined safety level.

2. The navigation process of claim 1, wherein the safety data is statistical crime data and highway safety data as a function of geographical area.

3. The navigation process of claim 1, wherein the predefined safety level is a user input safety level.

4. The navigation process of claim 1, wherein the user input safety level includes at least two user input safety levels with each safety level being a function of an individual user operating the motor vehicle.

5. The navigation process of claim 1, further including providing an alarm to the user if the first navigation route passes through an area having a safety level less than the predefined safety level.

6. The navigation process of claim 5, further including providing a query to the user as to whether or not to review one or more alerts related to the area having the safety level less than the predefined safety level.

7. The navigation process of claim 6, further including providing to the user the one or more alerts related to the area having the safety level less than the predefined safety level.

8. The navigation process of claim 7, wherein the one or more alerts are rated as a function of the safety data.

9. The navigation process of claim 7, further including providing a query to the user as to whether or not to ignore or select the one or more of the alerts provided to the user.

10. The navigation process of claim 9, further including providing a query to the user as to whether or not to calculate the second navigation route as a function of the alerts selected by the user.

11. The navigation process of claim 1, further including providing to the user one or more differences between the first navigation route and the second navigation route.

12. The navigation process of claim 11, wherein the one or more differences is selected from a group consisting of a difference in distance, a difference in time and a difference in distance and time.

13. The navigation process of claim 1, further including determining a safety level of a current location of the motor vehicle.

14. The navigation process of claim 13, further including providing the user with an alarm if the motor vehicle has entered an area having a safety level less than the predefined safety level.

15. The navigation process of claim 14, further including providing a query to the user as to whether or not to exit the area having a safety level less than the predefined safety level or continue as currently proceeding.

16. The navigation process of claim 15, further including providing a query to the user as to which type of route to take if the user selects to exit the area having a safety level less than the predefined safety level or continue as currently proceeding.

17. The navigation process of claim 16, wherein which type of route to take can be selected from a group consisting of a shortest route, a safest route and a fastest route.

18. A navigation process for providing an alternate route to a user when a suggested route passes through an area having a safety level less than a predefined safety level, the process comprising:
providing a navigation system operable to calculate a first navigation route and a second navigation route, the first navigation route being a function of a current location and a desired future location, and the second navigation route being a function of the first navigation route and safety data, the navigation system also operable to determine a safety level for an area the first navigation route passes through as a function of the safety data for the area;
providing a navigation request to the navigation system;
determining a first navigation route suing the navigation system;
determining a safety level for an area that the first navigation route passes through using the navigation system;
determining a second navigation route if the safety level is less than a predefined safety level, the second navigation route avoiding the area with the safety level less than the predefined safety level using the navigation system;
providing the user with the second navigation route if the safety level is less than the predefined safety level using the navigation system.

19. The navigation process of claim 18, wherein the safety data is statistical crime data and highway safety data as a function of geographical area.

20. The navigation process of claim 18, wherein the predefined safety level is a user input safety level.
